(19) United States
(12) Patent Application Publication
(10) Pub. No.: US 2016/0336886 A1
(43) Pub. Date: Nov. 17, 2016

(54) STEPPING MOTOR CONTROL DEVICE

(71) Applicant: KYOCERA Document Solutions Inc., Osaka (JP)

(72) Inventor: Hirotaka Ishida, Osaka-shi (JP)

(21) Appl. No.: 15/143,932

(22) Filed: May 2, 2016

(30) Foreign Application Priority Data
May 14, 2015 (JP) 2015-098892

(51) Int. Cl. H02P 8/10; H02P 8/38

(52) U.S. Cl. CPC H02P 8/10; H02P 8/38

(57) ABSTRACT

A stepping motor control device is a device for controlling a stepping motor to be driven by an input of a drive signal and includes a control signal generator and a drive signal generator. The control signal generator generates a predetermined control signal. The drive signal generator generates a drive signal for rotation by a predetermined step angle every time the control signal is input. The control signal generator sets a time interval between a first control signal for starting the stepping motor from a stopped state and a second control signal at one-third of a natural vibration frequency of the stepping motor.

### INCORPORATION BY REFERENCE

This application is based on Japanese Patent Application No. 2015-98892 filed with the Japan Patent Office on May 14, 2015, the contents of which are hereby incorporated by reference.

### BACKGROUND

The present disclosure relates to a technology on a control at the start-up of a stepping motor.

As a technology using a stepping motor, an automatic document feeder is proposed which includes a sheet feeding unit for feeding documents one by one, a conveying unit for conveying the fed document to an exposure position of a copier, a drive transmitting unit for transmitting a drive force to the conveying unit, a stepping motor for giving the drive force to the drive transmitting unit and a control unit for driving the stepping motor by a pulse number corresponding to backlash from the stepping motor to the conveying unit and a pulse number necessary for the phase matching of the stepping motor before the conveyance of the document.

Further, there is also proposed a position switch driving device which is designed to switch between at least two positions and includes a stepping motor, a drive shaft to be driven by the stepping motor, a rotating member configured to integrally rotate by being locked to the drive shaft, a returning member rotatably arranged and engaged with the rotating member and a biasing spring configured to bias the returning member, and in which a time until the rotating member is engaged with the returning member is set to be longer than an acceleration time at the start-up of the stepping motor.

### SUMMARY

A stepping motor control device according to one aspect of the present disclosure is a device for controlling a stepping motor to be driven by an input of a drive signal and includes a control signal generator and a drive signal generator. The control signal generator generates a predetermined control signal. The drive signal generator generates a drive signal for rotation by a predetermined step angle every time the control signal is input. The control signal generator sets a time interval between a first control signal for starting the stepping motor from a stopped state and a second control signal at one-third of a natural vibration frequency of the stepping motor.

### BRIEF DESCRIPTION OF THE DRAWINGS

FIG. 1 is a schematic diagram showing an example of the configuration of a stepping motor applied to an embodiment.

FIG. 2 is a block diagram showing the configuration of a stepping motor control device according to the embodiment.

FIG. 3 is a schematic diagram showing a state of the stepping motor before a first control signal is input to a drive current generator.

FIG. 4 is a schematic diagram showing a state of the stepping motor when the first control signal is input to the drive current generator.

FIG. 5 is a schematic diagram showing a state of the stepping motor when a second control signal is input to the drive current generator.

FIG. 6 is a time chart of control signals generated in a control signal generator when the start-up of the stepping motor is started in the stepping motor control device according to the embodiment.

FIG. 7 is a graph showing attenuation vibration of a rotor occurring at start-up in the stepping motor controlled by the stepping motor control device according to the embodiment,

FIG. 8 is a graph showing attenuation vibration of the rotor occurring at start-up in the stepping motor controlled by Comparative Example 1.

FIG. 9 is a graph showing attenuation vibration of the rotor occurring at start-up in the stepping motor controlled by Comparative Example 2.

FIG. 10 is a graph showing attenuation vibration of the rotor occurring at start-up in the stepping motor controlled by Comparative Example 3.

FIG. 11 is a time chart of control signals generated in the control signal generator when the start-up of the stepping motor is started in Modification 1.

FIG. 12 is a time chart of control signals generated in the control signal generator when the start-up of the stepping motor is started in Modification 2.

### DETAILED DESCRIPTION

The present disclosure is created from the following perspective. A stepping motor rotates a rotor by switching a rotation angle of the rotor in a stepwise manner. At this time, the rotor is attenuated and vibrated with a stability point as a center (in other words, an output torque of the stepping motor varies), which becomes a main cause of vibration during the low-speed operation of the stepping motor.

Since the stepping motor is operated at a low speed at the start-up thereof, measures against the vibration of the stepping motor, which causes attenuation vibration, are required.

The present disclosure aims to provide a stepping motor control device capable of suppressing vibration at the start-up of a stepping motor.

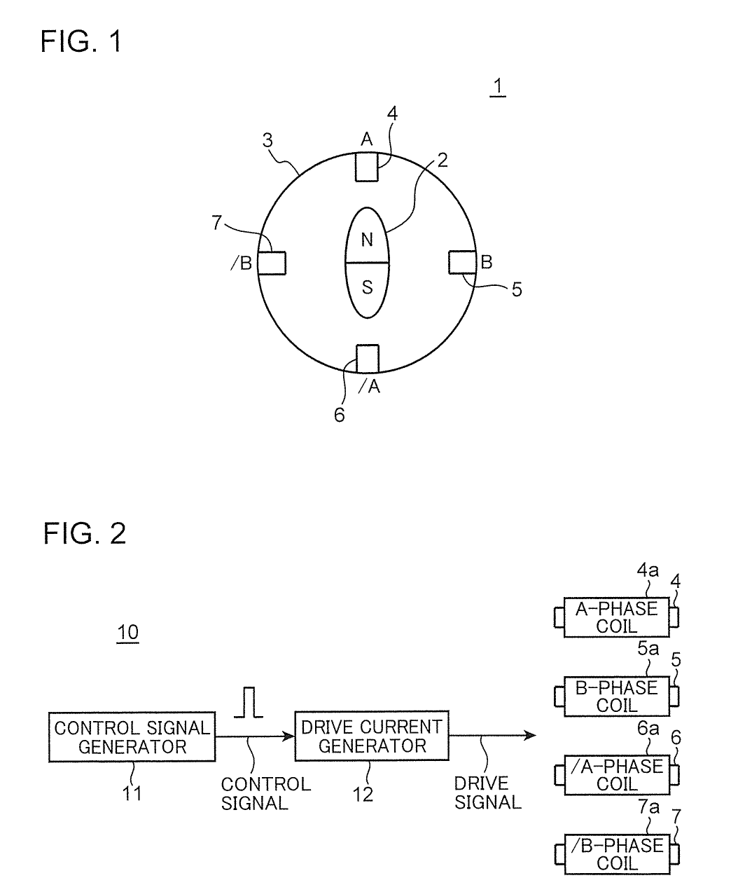

An embodiment of the present disclosure is described in detail on the basis of the drawings. FIG. 1 is a schematic diagram showing an example of the configuration of a stepping motor 1 applied to this embodiment. A rotor 2 is a permanent magnet having an N pole and an S pole. A stator 3 has an A-phase pole 4, a B-phase pole 5 located at a position where the rotor 2 is rotated 90° from the position of the A-phase pole 4, a /A-phase pole 6 located at a position where the rotor 2 is rotated 90° from the position of the B-phase pole 5 and a /B-phase pole 7 located at a position where the rotor 2 is rotated 90° from the position of the /A-phase pole 6.

FIG. 2 is a block diagram showing the configuration of a stepping motor control device 10 according to this embodiment. The stepping motor control device 10 includes a control signal generator 11 and a drive current generator 12.

The control signal generator 11 generates a pulse-like control signal having a predetermined pulse rate. The pulse rate can be rephrased as a frequency of the control signal.

The drive current generator 12 is a specific example of a drive signal generator and generates drive currents, which flow in an A-phase coil 4a, a B-phase coil 5a, a /A-phase coil 6a and a /B-phase coil 7a, based on the control signal generated in the control signal generator 11.

The A-phase pole 4 is excited by the drive current flowing in the A-phase coil 4a. The B-phase pole 5 is excited by the drive current flowing in the B-phase coil 5a. The /A-phase pole 6 is excited by the drive current flowing in the /A-phase coil 6a. The /B-phase pole 7 is excited by the drive current flowing in the /B-phase coil 7a.

The A-phase coil 4a and the /A-phase coil 6a are so connected that the drive current flowing in the A-phase coil 4a and that flowing in the /A-phase coil 6a are in opposite directions. The A-phase and the /A-phase are assumed as one phase.

The B-phase coil 5a and the /B-phase coil 7a are so connected that the drive current flowing in the B-phase coil 5a and that flowing in the /B-phase coil 7a are in opposite directions. The B-phase and the /B-phase are assumed as one phase.

The drive current generator 12 generates a drive current for rotation by a predetermined step angle every time the control signal is input when the drive current generator 12 is set in a 2 phase excitation mode. Note that “rotation by a predetermined step angle” means to rotate the rotor 2 of the stepping motor 1 by the step angle.

The step angle in a 1-2 phase excitation system is half the step angle in a 2 phase excitation system and the step angle in a 1-2 phase excitation system is the quarter of the step angle in the 2-phase excitation system.

The operation of the stepping motor 1 is described using FIGS. 2 to 5, taking the 2 phase excitation system as an example.

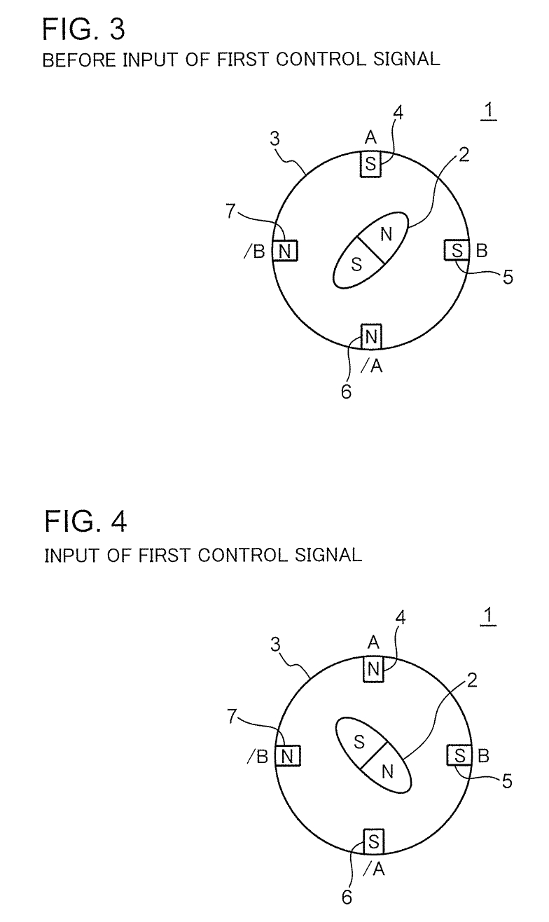

FIG. 3 is a schematic diagram showing a state of the stepping motor 1 before a first control signal is input to the drive current generator 12. The rotor 2 of the stepping motor 1 is in a rotation stopped state. With reference to FIGS. 2 and 3, the drive currents generated in the drive current generator 12 flow in the A-phase coil 4a, the B-phase coil 5a, the /A-phase coil 6a and the /B-phase coil 7a such that the A-phase pole 4 becomes the S pole, the B-phase pole 5 becomes the S pole, the /A-phase pole 6 becomes the N pole and the /B-phase pole 7 becomes the N pole.

FIG. 4 is a schematic diagram showing a state of the stepping motor 1 when the first control signal is input to the drive current generator 12. With reference to FIGS. 2 and 4, it is assumed that the first control signal generated in the control signal generator 11 is input to the drive current generator 12. This causes the drive currents generated in the drive current generator 12 to flow in the A-phase coil 4a, the B-phase coil 5a, the /A-phase coil 6a and the /B-phase coil 7a such that the A-phase pole 4 becomes the N pole, the B-phase pole 5 becomes the S pole, the /A-phase pole 6 becomes the S pole and the /B-phase pole 7 becomes the N pole. Thus, the rotor 2 is rotated by the step angle of 90° from the position shown in FIG. 3.

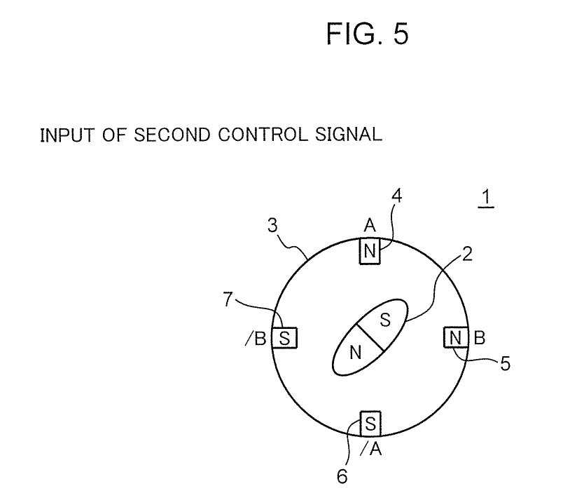

FIG. 5 is a schematic diagram showing a state of the stepping motor 1 when a second control signal is input to the drive current generator 12. With reference to FIGS. 2 and 5, it is assumed that the second control signal generated in the control signal generator 11 is input to the drive current generator 12. This causes the drive currents generated in the drive current generator 12 to flow in the A-phase coil 4a, the B-phase coil 5a, the /A-phase coil 6a and the /B-phase coil 7a such that the A-phase pole 4 becomes the N pole, the B-phase pole 5 becomes the N pole, the /A-phase pole 6 becomes the S pole and the /B-phase pole 7 becomes the S pole. Thus, the rotor 2 is rotated by the step angle of 90° from the position shown in FIG. 4.

In this way, the phase of the stepping motor 1 is switched and the rotor 2 is rotated by one step angle every time the control signal generated in the control signal generator 11 is input to the drive current generator 12. The control signal is a signal indicating a command to rotate the rotor 2 from the current rotation angle to the next rotation angle (i.e. rotation angle after the rotation of one step angle).

As described above, the 2 phase excitation system is a system for driving the stepping motor 1 by repeating 2 phase excitation and is also called full-step drive. Out of two phases, one phase is composed of the A-phase and the /A-phase and the other phase is composed of the B-phase and the /B-phase.

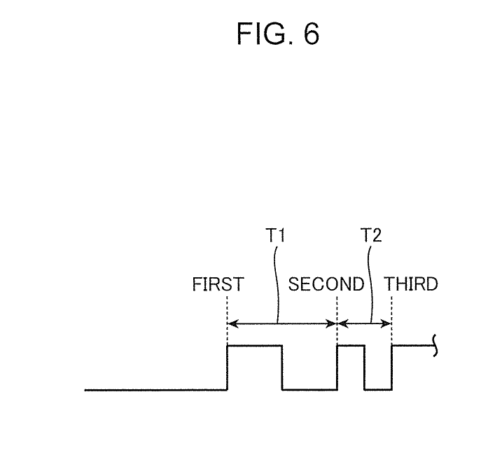

FIG. 6 is a time chart of control signals generated in the control signal generator 11 when the start-up of the stepping motor 1 is started in the stepping motor control device 10 according to this embodiment. The control signal generator 11 sets a time interval T1 between a first control signal for the start-up of the stepping motor 1 from a stopped state and a second control signal at one-third of a natural vibration frequency of the stepping motor 1 and sets a time interval T2 between the second and third control signals at one-sixth of the natural vibration frequency.

The natural vibration frequency of the stepping motor 1 is derived from a moment of inertia of the rotor 2 and a maximum torque of the stepping motor 1 and expressed by the following equation.

T0=(n·T_{H}/JT)^{0.5}/4π

Here, T0 denotes the natural vibration frequency, JT denotes the moment of inertia of the rotor 2, T_{H} denotes the maximum torque and n denotes a step number per rotation at the time of the full-step drive.

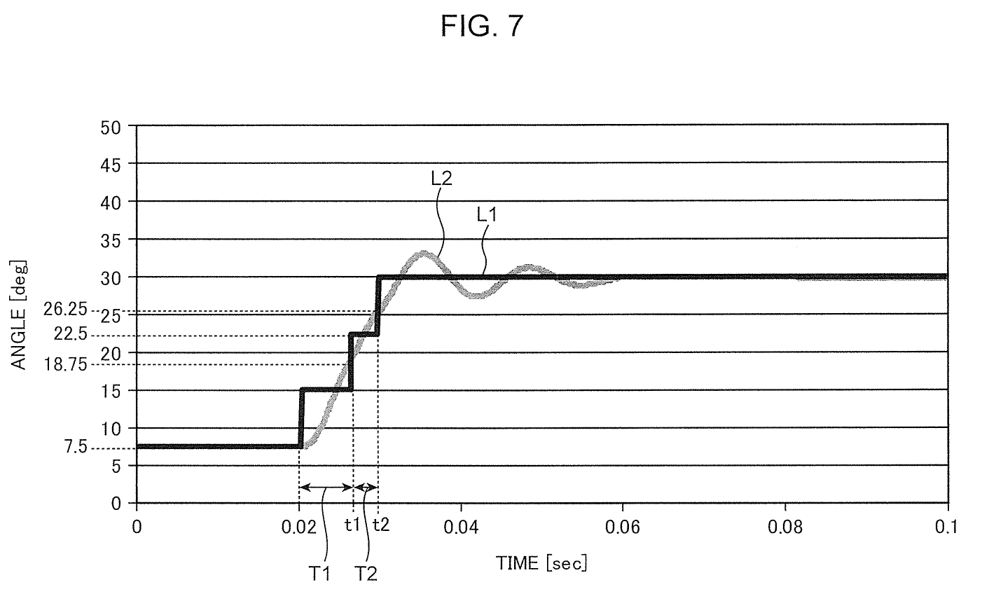

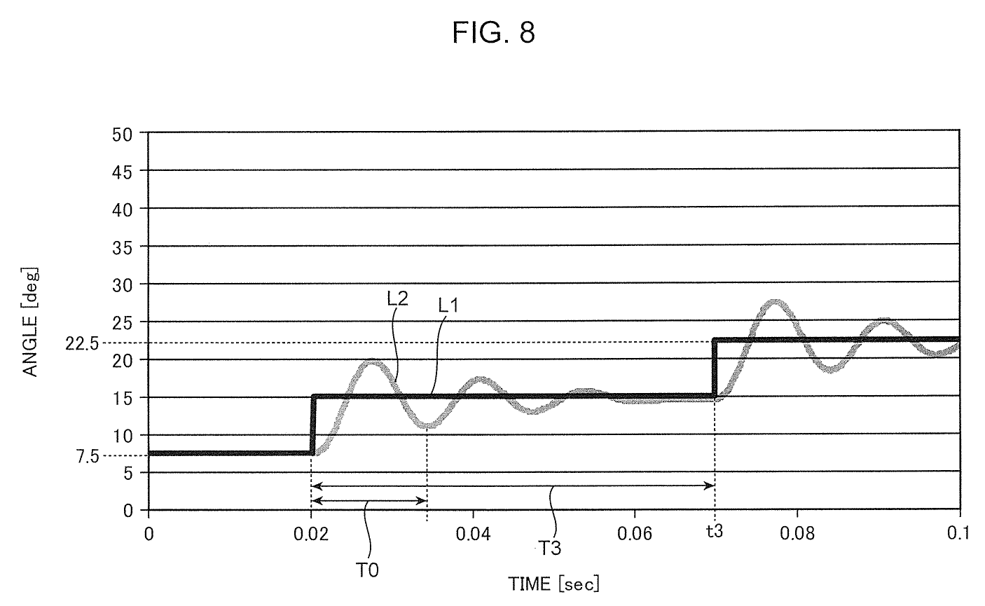

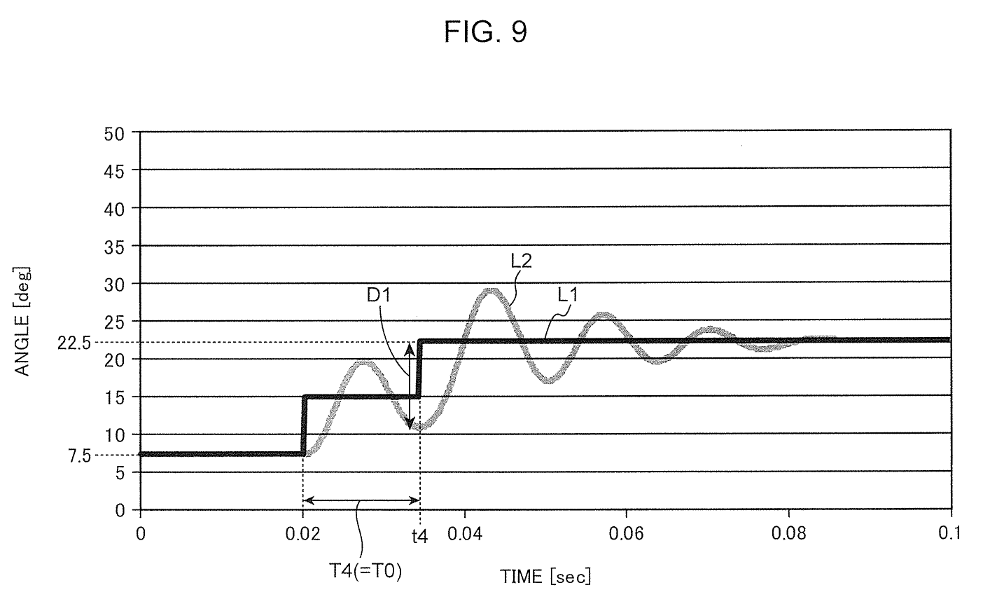

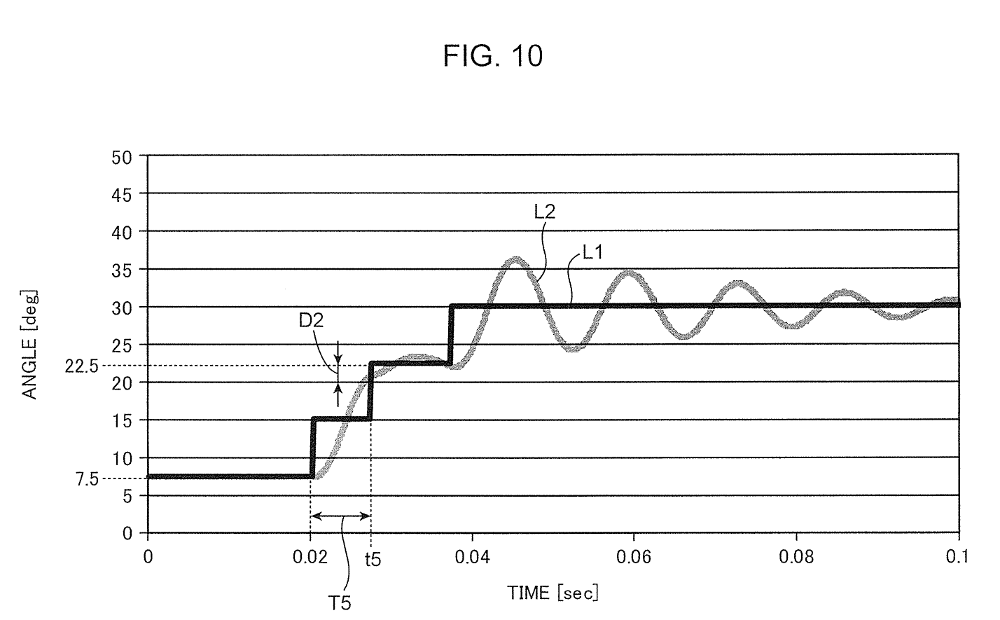

A control of the stepping motor 1 using the stepping motor control device 10 according to this embodiment is described in comparison to comparative examples. FIG. 7 is a graph showing attenuation vibration of the rotor 2 occurring at start-up in the stepping motor 1 controlled by the stepping motor control device 10 according to this embodiment. FIG. 8 is a graph showing attenuation vibration of a rotor 2 occurring at start-up in the stepping motor 1 controlled by Comparative Example 1. FIG. 9 is a graph showing attenuation vibration of the rotor 2 occurring at start-up in the stepping motor 1 controlled by Comparative Example 2. FIG. 10 is a graph showing attenuation vibration of the rotor 2 occurring at start-up in the stepping motor 1 controlled by Comparative Example 3.

In FIGS. 7 to 10, a horizontal axis represents elapsed time from the start of the start-up and its unit is second. A vertical axis represents the rotation angle of the rotor 2 and its unit is degree. In controls of this embodiment and Comparative Examples 1 to 3, it is assumed that the step angle is 7.5° and an initial value of the rotation angle of the rotor 2 is 7.5°. The initial value of 7.5° means that the start-up is started in a state where the rotation angle of the rotor 2 is 7.5°.

A line shown by L1 and changing in a stepwise manner indicates a time change of a stability point of the rotor 2. A line shown by L2 indicates a motion of the rotor 2. It is found that the rotor 2 is attenuated and vibrated with the stability point as a center.

First, this embodiment is described. With reference to FIG. 7, when 0.02 seconds elapse after the start of the start-up of the stepping motor 1, a first control signal is input to the drive current generator 12. This causes a second control signal to be input to the drive current generator 12 when the rotor 2 first reaches a rotation angle of 18.75° beyond a rotation angle of 15° (time t1) during an operation of rotating the rotor 2 from a rotation angle of 7.5° to the rotation angle of 15°. 18.75° is a rotation angle in the middle between the rotation angle of 15° by the first control signal and that of 22.5° by the second control signal.

When the second control signal is input to the drive current generator 12 at such a timing, the vibration of the rotor 2 can be almost eliminated during a period (time interval T1) until the second control signal is input to the drive current generator 12 after the first control signal is input.

The second control signal is input to the drive current generator 12 at time t1. This causes a third control signal to be input to the drive current generator 12 when the rotor 2 first reaches a rotation angle of 26.25° beyond the rotation angle of 22.5° (time t2) during an operation of rotating the rotor 2 from the rotation angle of 15° to the rotation angle of 22.5°. 26.25° is a rotation angle in the middle between the rotation angle of 22.5° by the second control signal and that of 30° by the third control signal.

When the third control signal is input to the drive current generator 12 at such a timing, the vibration of the rotor 2 can be almost eliminated during a period (time interval T2) until the third control signal is input to the drive current generator 12 after the second control signal is input.

It was found that this could be realized when the time interval T1 between the first and second control signals was set at one-third of the natural vibration frequency T0 and the time interval T2 between the second and third control signals was set at one-sixth of the natural vibration frequency T0.

More specifically, the first control signal is input to the drive current generator 12 at a timing of 0.02 seconds. This causes the rotation angle of the rotor 2 to advance one step angle and be switched from 7.5° to 15°. The second control signal is input to the drive current generator 12 at a timing of t1 seconds. This causes the rotation angle of the rotor 2 to advance one step angle and be switched from 15° to 22.5°. The time interval T1 between 0.02 seconds and t1 seconds is one-third of the natural vibration frequency T0. The third control signal is input to the drive current generator 12 at a timing of t2 seconds. This causes the rotation angle of the rotor 2 to advance one step angle and be switched from 22.5° to 30°. The time interval T2 between t1 seconds and t2 seconds is one-sixth of the natural vibration frequency T0.

What fractions of the natural vibration frequency T0 the subsequent time intervals (time interval between the third and fourth control signals, time interval between fourth and fifth control signals, . . . ) can be mathematically calculated. However, the calculated time intervals and actually necessary time intervals do not match as a result of accumulated errors due to disturbances. Further, since a rotation speed of the rotor 2 has reached a sufficient value by the control signals up to the third one, necessity to set the above time intervals for the control signals after the third one is low. Thus, the time interval T1 between the first and second control signals is set at one-third of the natural vibration frequency T0, the time interval T2 between the second and third control signals is set at one-sixth of the natural vibration frequency T0 and a relationship with the natural vibration frequency T0 is not considered for the subsequent time intervals.

That the time interval T1 is one-third of the natural vibration frequency T0 may mean that the time interval T1 perfectly coincides with one-third of the natural vibration frequency T0 or substantially coincides therewith within a range where an effect of suppressing vibration at start-up is obtained. Similarly, that the time interval T2 is one-sixth of the natural vibration frequency T0 may mean that the time interval T2 perfectly coincides with one-sixth of the natural vibration frequency T0 or substantially coincides therewith within a range where the effect of suppressing vibration at start-up is obtained. Note that it is not essential to set the time interval T2 at one-sixth of the natural vibration frequency T0. The effect of suppressing vibration at start-up is obtained if the time interval T1 is set at one-third of the natural vibration frequency T0.

Next, Comparative Example 1 is described. With reference to FIG. 8, a time interval T3 between first and second control signals is set to be longer than the natural vibration frequency T0. The first control signal is input to the drive current generator 12 at a timing of 0.02 seconds. This causes the rotation angle of the rotor 2 to advance one step angle and be switched from 7.5° to 15°. The second control signal is input to the drive current generator 12 at a timing of t3 seconds (=0.07 seconds). This causes the rotation angle of the rotor 2 to advance one step angle and be switched from 15° to 22.5°.

It is found that the rotor 2 is attenuated and vibrated during the time interval T3. A frequency of the first vibration of the attenuation vibration coincides with the natural vibration frequency T0.

Comparative Example 2 is described. With reference to FIG. 9, a time interval T4 between first and second control signals is set to be equal to the natural vibration frequency T0. The first control signal is input to the drive current generator 12 at a timing of 0.02 seconds. This causes the rotation angle of the rotor 2 to advance one step angle and be switched from 7.5° to 15°. The second control signal is input to the drive current generator 12 at a timing of t4 seconds. This causes the rotation angle of the rotor 2 to advance one step angle and be switched from 15° to 22.5°.

It is found that the rotor 2 is largely attenuated and vibrated since a difference D1 between the rotation angle (about 11°) of the rotor 2 at t4 seconds and the next rotation angle of 22.5° is large.

Comparative Example 3 is described. With reference to FIG. 10, a time interval T5 between first and second control signals is set to be half the natural vibration frequency T0. The first control signal is input to the drive current generator 12 at a timing of 0.02 seconds. This causes the rotation angle of the rotor 2 to advance one step angle and be switched from 7.5° to 15°. The second control signal is input to the drive current generator 12 at a timing of t5 seconds. This causes the rotation angle of the rotor 2 to advance one step angle and be switched from 15° to 22.5°.

It is found that a difference D2 between the rotation angle (about 21°) of the rotor 2 at t5 seconds and the next rotation angle of 22.5° is very small and, thereafter, the rotor 2 is largely attenuated and vibrated due to reaction to that.

As described above, according to this embodiment, vibration at the start-up of the stepping motor 1 can be suppressed as compared to Comparative Examples 1 to 3.

The stepping motor 1 is used in a mechanism for moving a carriage (an exposure lamp and the like are carried on the carriage) provided in a document reading unit of an image forming apparatus. If the carriage vibrates, accuracy in reading a document is reduced. Thus, the stepping motor control device 10 according to this embodiment is preferable as a device for controlling the stepping motor 1 for moving the carriage.

A modification of this embodiment is described. The stepping motor control device 10 shown in FIG. 2 executes a series of controls of slow-up, constant speed operation and slow-down for the stepping motor 1. In the modification, these controls are assumed. The slow-up is a control for gradually increasing the rotation speed of the rotor 2 to cause the rotation speed to reach a target value by gradually increasing the frequency of the control signal. The constant speed operation is a control for maintaining the rotation speed of the rotor 2 at the target value. The slow-down is a control for gradually reducing the rotation speed of the rotor 2 to stop the rotation of the rotor 2 by gradually reducing the frequency of the control signal.

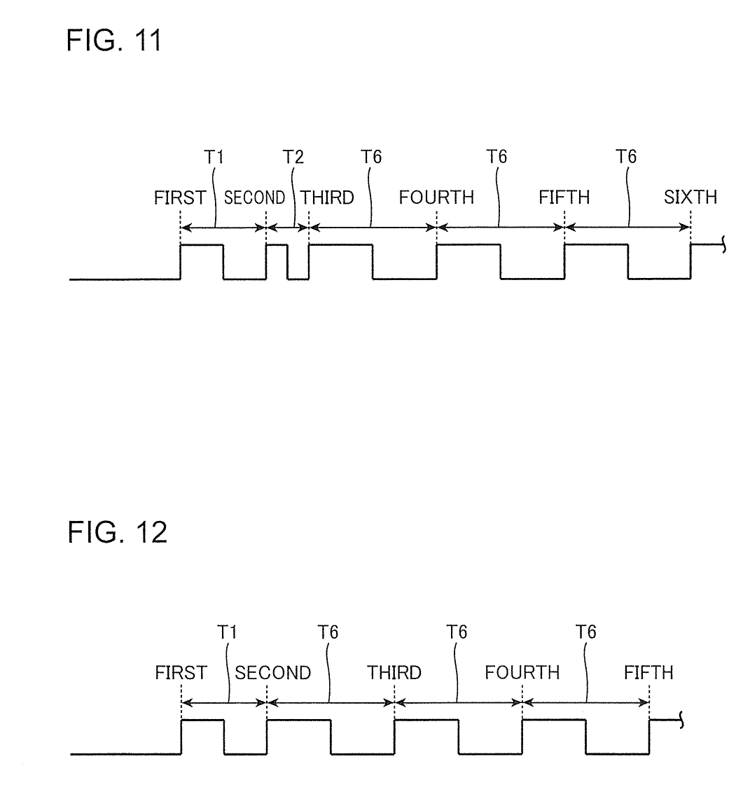

FIG. 11 is a time chart of control signals generated in the control signal generator 11 when the start-up of the stepping motor 1 is started in Modification 1. The control signal generator 11 sets the time interval T1 between the first and second control signal at one-third of the natural vibration frequency t0 and the time interval T2 between the second and third control signals at one-sixth of the natural vibration frequency T0. The control signal generator 11 starts the slow-up of the stepping motor 1 by generating the control signals after the third one at a period T6 longer than the time interval T1.

FIG. 12 is a time chart of control signals generated in the control signal generator 11 when the start-up of the stepping motor 1 is started in Modification 2. The control signal generator 11 sets the time interval T1 between the first and second control signal at one-third of the natural vibration frequency to. The control signal generator 11 starts the slow-up of the stepping motor 1 by generating the control signals after the second one at the period T6 longer than the time interval T1.

Since the time interval T1 is one-third of the natural vibration frequency t0, it is short as a period of the control signal when the slow-up is started. Thus, if the slow-up is started by the control signal having a period shorter than the time interval T1, the stepping motor 1 may step out. According to Modifications 1 and 2, it is possible to suppress vibration and prevent the step-out at the start-up of the stepping motor 1.

1. A stepping motor control device for controlling a stepping motor to be driven by an input of a drive signal, comprising:
a control signal generator for generating a predetermined control signal; and
a drive signal generator for generating the drive signal for rotation by a predetermined step angle every time the control signal is input, wherein
the control signal generator sets a time interval between a first control signal for starting the stepping motor from a stopped state and a second control signal at one-third of a natural vibration frequency of the stepping motor.

2. A stepping motor control device according to claim 1, wherein the control signal generator sets a time interval between the second control signal and a third control signal at one-sixth of the natural vibration frequency.
